(19) United States
(12) Patent Application Publication
(10) Pub. No.: US 2021/0291451 A1
(43) Pub. Date: Sep. 23, 2021

(54) SEMI-PERMEABLE ELEMENT, USE THEREOF AND PREPARATION METHOD THEREFOR AND 3D PRINTING DEVICE

(71) Applicant: FUJIAN INSTITUTE OF RESEARCH ON THE STRUCTURE OF MATTER, CHINESE ACADEMY OF SCIENCE, Fuzhou (CN)

(72) Inventors: Wenxiong LIN, Fuzhou (CN); Jianhong HUANG, Fuzhou (CN); Kaiming RUAN, Fuzhou (CN); Huagang LIU, Fuzhou (CN); Haizhou HUANG, Fuzhou (CN); Hongchun WU, Fuzhou (CN); Zhi ZHANG, Fuzhou (CN); Jinming CHEN, Fuzhou (CN); Jinhui LI, Fuzhou (CN); Wen WENG, Fuzhou (CN); Yan GE, Fuzhou (CN); Zixiong LIN, Fuzhou (CN)

(73) Assignee: FUJIAN INSTITUTE OF RESEARCH ON THE STRUCTURE OF MATTER, CHINESE ACADEMY OF SCIENCE, Fuzhou (CN)

(21) Appl. No.: 17/340,446

(22) Filed: Jun. 7, 2021

Related U.S. Application Data
(62) Division of application No. 16/069,969, filed on Jul. 13, 2018.

(51) Int. Cl. B29C 64/291; B33Y 30/00; B29C 64/255

(52) U.S. Cl. CPC B29C 64/291; B33Y 10/00; B29C 64/255; B33Y 30/00

(57) ABSTRACT

A semipermeable element for the penetration of 3D printing curing inhibitors. The semipermeable element has a pore density of 107-1011/cm2, and/or the pore diameter of 0.01 μm-5 μm. A usage of a semipermeable element, and manufacturing method thereof as well as a 3D printing apparatus. The semipermeable element has good permeability to the curing inhibitor, and simply introducing air can achieve the thickness of inhibited curing layer as required by the continuous manufacturing of the three-dimensional objects.

### CROSS-REFERENCE TO RELATED APPLICATIONS

This is a Divisional application of a non-provisional application having U.S. patent application Ser. No. 16/069,969 filed on Jul. 13, 2018, and the National Phase application of International Application No. PCT/CN2016/070838 filed on Jan. 13, 2016, which is hereby incorporated by reference into the present disclosure.

### FIELD

The present invention relates to the technical field of 3D printing, in particular to a semipermeable element, usage and manufacturing method thereof and a 3D printing apparatus.

### BACKGROUND

Three-dimensional manufacturing (also called “3D printing”) is a technology that constructs three-dimensional objects by means of layer-by-layer printing and layer-by-layer accumulating based on digital model files. In particular, a three-dimensional object is constructed by layer-by-layer curing of a photosensitive resin by irradiating visible light or ultraviolet light, which is commonly referred to as stereolithography (SLA).

In current SLA technology, one is a layer-by-layer light curing. Reference may be made to a Chinese patent application No. 201410795471.6 with a title of “a laser 3D printer with a scraping function and its light-curing printing method”. During the implementation of this method, light irradiation has to be interrupted between the layers, waiting for a precise and uniform print solution layer covering on or filling the surface of the cured area, and then light irradiation resumes to form a new cured layer. Thus a three-dimensional object is constructed layer by layer. The disadvantage of this layer-by-layer curing technique is that after each layer is cured, a complicated mechanical motion device has to be activated to scrape the surface so as to reform a precise and uniform liquid photosensitive resin coating, which complicates the apparatus and takes too much time.

For a method of continuously constructing a three-dimensional object, reference may be made to a Chinese Patent Application No. 201480008397.7 with a title “a method and an apparatus for three-dimensional manufacturing”. This technique introduces a polymerization inhibitor through a semipermeable element to form a liquid film release layer composed of a photosensitive resin liquid between a constructing surface and a polymerization area, thereby eliminating the need to stop light irradiation and perform the filling and scraping of a new liquid surface layer after the completion of one layer of curing. Thus it can continuously construct three-dimensional objects. However, the semipermeable elements used in this technique are high-molecular polymers or porous glass. These elements are either flexible materials or have small pore diameters and a micropore structure of a sponge-like labyrinth. Therefore the permeability of the curing inhibitor (mainly oxygen) is so poor that in some embodiments pure oxygen or pressurization is needed to increase the permeability.

### SUMMARY

In order to overcome the low permeability of semipermeable elements or the insufficiency of flexible films in existing 3D printing apparatus, the present invention provides a semipermeable element for the penetration of 3D printing curing inhibitors and its usage and a manufacturing method as well as a 3D printing apparatus. The permeability of semipermeable element to the curing inhibitor is high, and simply introducing air can achieve the thickness of inhibited curing layer as required by the continuous manufacturing of the three-dimensional objects.

The present invention provides a semipermeable element for the penetration of 3D printing curing inhibitors, wherein the semipermeable element has a pore density of 10⁷-10¹¹/cm², and/or the pore diameter of 0.01 μm-5 μm.

According to the present invention, the semipermeable element has a gas permeability of no less than 100 bar. It is used for the penetration of the gaseous curing inhibitors.

According to the invention, the semipermeable element has a pore density of 10⁸-10¹⁰/cm², and/or has a pore diameter of 0.02 μm-0.2 μm.

Further, the gas permeability is no less than 120 bar, and may be no less than 150 bar.

Further, the semipermeable element is manufactured by using nuclear track etching technology to etch micropores on an optically transparent substrate material, wherein the density and diameter of the pores may be controlled as required during manufacturing.

Further, the substrate material includes polycarbonate (PC), polyethylene terephthalate (PET), polyimide (PI), polyethylene (PE), polypropylene (PP), quartz crystal, mica or combinations thereof.

Preferably, the substrate material is quartz crystal or mica, alternatively the substrate material includes quartz crystal and/or mica.

Further, rigid support elements are provided outside or inside the semipermeable element for increasing the rigidity of the semipermeable element.

Further, the present invention also provides a usage of a semipermeable element as described above in 3D printing.

Further, the present invention also provides a method for manufacturing a semipermeable element as described above, the method comprising the following steps: step (1): by irradiating the optically transparent substrate material with nuclear reaction fission fragments, or with an accelerator heavy ion beam, leaving an irradiation path on the substrate material; and step (2): performing chemical etching to etch micropores on the substrate material irradiated as previously mentioned so as to manufacture the semipermeable element. In addition, the present invention also proposes a 3D printing apparatus, the 3D printing app apparatus comprising a semipermeable element as previously described and a liquid tank, wherein the semipermeable element constitutes the bottom of the liquid tank or a part of the bottom and the liquid tank and the semipermeable element constitute a container for the polymerizable liquid; alternatively wherein the semipermeable element constitutes the top of the liquid tank or a part of the top, and the liquid tank and the semipermeable element constitute a closed or partially closed container for the polymerizable liquid; alternatively wherein the semipermeable element is located in the liquid tank.

Further, the 3D printing apparatus further includes a curing inhibitor source for providing a storage or circulation area for the curing inhibitor; the curing inhibitor source is located between the semipermeable element and the light source of the 3D printing apparatus and is attached to the semipermeable element; the surface of the semipermeable element that faces away from the light source is a manufacturing surface, and the curing inhibitor can penetrate the semipermeable element to form a liquid inhibited curing layer on the manufacturing surface.

According to the present invention, the curing inhibitor or polymerization inhibitor used in the present invention may be in liquid or gaseous. In some embodiments, preferably gas inhibitors are gas. The specific inhibitor depends on the polymerized monomers and the polymerization reaction. For free-radical polymerizable monomers, the inhibitor may conveniently be oxygen, which may be provided in the form of gas, such as air, oxygen-enriched gas (optionally, but in some embodiments, it is preferable to contain other inert gas to reduce their flammability), or in some embodiments, the inhibitor may be pure oxygen. In some embodiments, for example, the monomers are polymerized by a photoacid generator initiator, the inhibitor may be alkalis such as ammonia, trace amines (for example methylamine, ethylamine, di- and trialkylamines such as dimethylamine, diethylamine, trimethylamine, triethylamine, etc.) or carbon dioxide, including their mixtures or combinations.

Further, when the semipermeable element constitutes the bottom of the liquid tank or a part of the bottom, the upper surface of the semipermeable element is a manufacturing surface, together with which the lower surface of the workbench of the 3D printing apparatus form the construction zone for the three-dimensional object; and in that the curing inhibitor is able to penetrate into the construction zone through the semipermeable element and forms a liquid inhibited curing layer on the manufacturing surface.

Further, when the semipermeable element is locate inside the liquid tank, the lower surface of the semipermeable element is a manufacturing surface, together with which the upper surface of the workbench of the 3D printing apparatus form the construction zone for the three-dimensional object; and in that the curing inhibitor is able to penetrate into the construction zone through the semipermeable element and forms a liquid inhibited curing layer on the manufacturing surface. According to the present invention, the semipermeable element is fixed on a support element which is a rigid, optically transparent element. Grooves are carved on the surface of the support element for the passage of gas. The curing inhibitors may flow through these grooves to penetrate to the manufacturing surface.

The beneficial effects of the present invention are as follows:

1. The semipermeable element according to the present invention has a nearly cylindrical straight hole structure and has a better permeability to the gaseous curing inhibitor than ordinary polymers. With the same porosity (for example 5%), the permeability can be increased by at least 20%-30%, at most up to 5 times of the permeability of semipermeable polymers (such as a sponge-like microporous polymers), or even 10 times.

2. The method for manufacturing a semipermeable element provided by the present invention can control the pore density and the pore diameter of the semipermeable element as required, and improve the accuracy and speed of 3D printing. The 3D printing apparatus using the semipermeable element as described above can achieve a speed of more than 600 mm/h during three-dimensional object construction.

3. The semipermeable element proposed by the present invention includes rigid support elements such as quartz crystal, mica, etc. to overcome the deficiency of the flexible material. The rigid support elements are used to fix or flatten the semipermeable element.

### BRIEF DESCRIPTION OF THE DRAWINGS

FIG. 1 is a schematic view of the structure and the principle of the 3D printing apparatus according to the invention.

FIG. 2 is a schematic view of an embodiment of the semipermeable element according to the present invention.

FIG. 3 is a schematic view of an embodiment of the 3D printing apparatus according to the invention.

FIG. 4 is a schematic view of another embodiment of the 3D printing apparatus according to the invention.

FIG. 5 is scanning electron microscope view of the semipermeable element of another embodiment of the 3D printing apparatus according to the invention.

### DETAILED DESCRIPTION

The objects, technical solutions and advantages of the present invention will become more apparent from the following description which is described in further detail by way of embodiments and with reference to the accompanying drawings. However, those skilled in the art should understand that the present invention is not limited to the accompanying drawings and the embodiments below. The semipermeable element provided by the present invention is manufactured by using nuclear track etching technology to etch micropores on an optically transparent substrate material. In particular, by irradiating the substrate material with nuclear reaction fission fragments, or with an accelerator heavy ion beam, then after chemical etching, nearly cylindrical straight holes are made, and the density and diameter of the pores may be controlled as required. The semipermeable element has a pore density of 10⁷-10¹¹/cm², and/or has a pore diameter of 0.01 μm-5 μm, and a gas permeability of no less than 100 bar. Preferably, the semipermeable element has a pore density of 10⁸-10¹⁰/cm², and/or has a pore diameter of 0.02 μm-0.2 μm.

According to the invention, the substrate material includes polycarbonate (PC), polyethylene terephthalate (PET), polyimide (PI), polyethylene (PE), polypropylene (PP), quartz crystal, mica or combinations thereof. For crystalline materials, due to the anisotropic nature, uniform columnar pores can be obtained in a specific direction. And since it is rigid material, the limitations of flexible materials can be overcome.

Due to the flexible nature of certain semipermeable elements, rigid support elements may be provided outside or inside the semipermeable elements for increasing the rigidity of the semipermeable elements. For example, the support elements may stretch, flatten or fasten the semipermeable element to increase the rigidity of the semipermeable element. The support element allows the energy of the light source to pass through when it is positioned in the irradiation path of the light source and allows the polymerization inhibitor to pass through when it is positioned in the permeation path of the polymerization inhibitor.

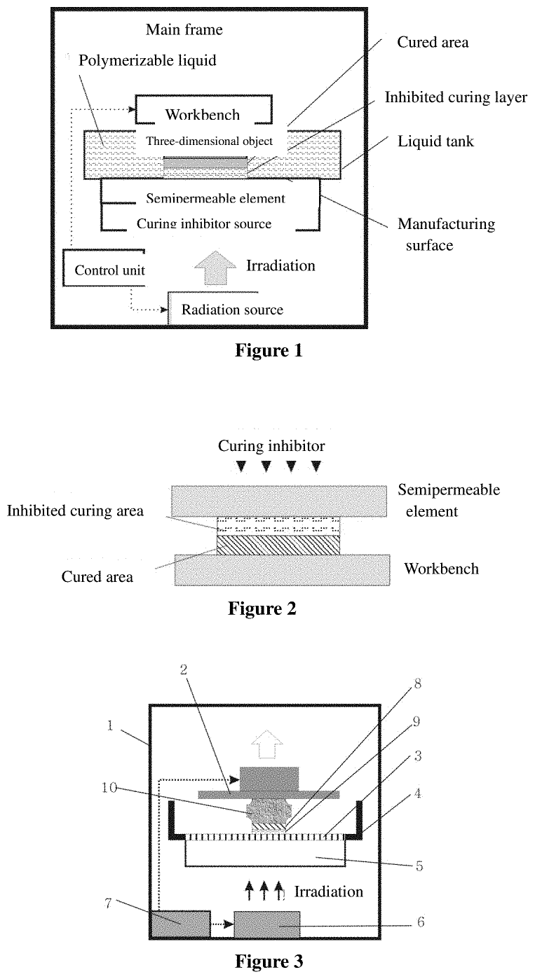

The schematic view of the structure and the principle of the 3D printing apparatus according to the invention using the semipermeable element as previously described is shown in FIG. 1. The apparatus includes: (a) a main frame for the connection or fixation of other parts and elements; (b) a workbench on which the three-dimensional object is constructed and which can bring the three-dimensional object up and down; (c) a semipermeable element which is an optically transparent element and permeable to curing inhibitor (oxygen), a surface of the semipermeable element near the workbench being a manufacturing surface, and a construction zone of a three-dimensional object being delimited between the manufacturing surface and the workbench, and the curing inhibitor penetrating onto the manufacturing surface through the semipermeable element; (d) a liquid tank, wherein in some embodiments, the liquid tank and the semipermeable element form a container for the polymerizable liquid which is fixed between the workbench and the curing inhibitor source, wherein the manufacturing surface is the inner bottom surface of the container for the polymerization liquid or a part of the inner bottom surface and wherein during the implementation of the process of 3D printing the manufacturing surface has to be covered with a layer of polymerizable liquid with a thickness of no less than 0.1 mm In some embodiments, the liquid tank is fixed below the manufacturing surface and the workbench, with the polymerizable liquid level not lower than the manufacturing surface so as to ensure that the manufacturing surface is in contact with the polymerizable liquid; (e) a curing inhibitor source providing a storage and circulation area for the curing inhibitor, preferably an optically transparent container; (f) a light source irradiating the construction zone through the curing inhibitor source and the semipermeable element and initiating the curing of the polymerizable liquid; and (g) a controller which connects the workbench and the light source and controls the movement of the workbench and the intensity and shape of the radiation of the light source.

The light source irradiates the construction zone through the curing inhibitor source and the semipermeable element, and initiates the curing of the polymerizable liquid in the construction zone, and forms a cured area. Due to the presence of the curing inhibitor, a liquid inhibited curing layer is formed between the cured area and the semipermeable element; when the workbench drives the three-dimensional object to move, due to the liquid inhibited curing layer thus formed, the cured area and the semipermeable element can be easily separated. The schematic view of inhibited curing layer and the cured area is shown in FIG. 2. The 3D printing apparatus using the semipermeable element as described above can achieve the continuous construction of a three-dimensional object with a speed of more than 600 mm/h.

Embodiment 1:

FIG. 3 is an embodiment of the 3D printing apparatus as previously mentioned using the semipermeable element described above. This embodiment constructs a three-dimensional object in a “bottom-up” way.

The apparatus includes the following structure:

a main frame 1 constituting the frame structure of the apparatus;

a workbench 2 on which a three-dimensional object is constructed and which connects with a one-dimensional electric platform, wherein the workbench 2 is driven by the one-dimensional electric platform to move up and down under the control of a controller 7;

a semipermeable element 3 which is an optically transparent, oxygen-permeable element and which is manufactured using a nuclear track etching technique; in this embodiment, the semipermeable element has a pore density of 10⁷/cm², and a pore diameter of 1 μm. The gas permeability is no less than 100 bar. a liquid tank 4, wherein the semipermeable element 3 and the liquid tank 4 constitute a container for the polymerizable liquid, the surface of the semipermeable element 3 near the workbench being a manufacturing surface of the three-dimensional object and as the bottom of the container for the polymerizable liquid container, and wherein a construction zone of the three-dimensional object 10 is formed between the lower surface of the workbench 2 and the manufacturing surface;

a curing inhibitor source 5 used to provide a curing inhibitor, wherein the lower surface of the semipermeable element 3 is in contact with the curing inhibitor source 5, and the curing inhibitor can penetrate into the construction zone through the semipermeable element 3 and form a liquid inhibited curing layer 9 between the manufacturing surface and the cured area 8. In this embodiment, oxygen or air is used as the curing inhibitor;

a light source 6 which is located below the semipermeable element 3, and irradiates the construction zone through the semipermeable element 3 to initiate the curing of the polymerizable liquid; and

a controller 7 which connects and controls the light source 6 and the workbench 2.

The operation of the apparatus is as follows:

(1) adding a sufficient amount of polymerizable liquid (sufficient to form the final three-dimensional object) into the liquid tank 4, and lowering the workbench 2 and getting closed to the covering surface;

(2) irradiating the construction zone with the light source 6 and introducing the curing inhibitor. In this step, the light source 6 irradiates the construction zone to form a cured area 8, and the curing inhibitor in the curing inhibitor source 5 is enriched on the manufacturing surface through the semipermeable element 3. Due to the effect of the curing inhibitor, a liquid inhibited curing layer 9 is formed between the manufacturing surface and the cured area 8;

(3) moving the workbench 2 away from the manufacturing surface under the control of the controller 7. With the presence of the liquid inhibited curing layer 9, the cured area 8 is easily and non-destructively separated from the manufacturing surface to form a subsequent construction zone, into which the polymerizable liquid is filled;

(4) repeating the above steps (2) and (3) and performing the layer-by-layer deposition until the final three-dimensional object 10 is formed.

Compared with commercially available sponge-like microporous polymer as the semipermeable elements, the gas permeability of the semipermeable element according to the present invention increases by 5 times, and the printing speed of the 3D printing apparatus can reach 500 mm/h.

Embodiment 2:

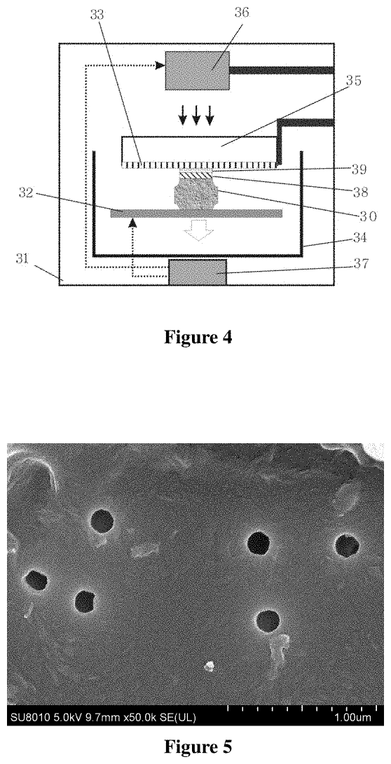

FIG. 4 is another embodiment of the 3D printing apparatus as previously mentioned using the semipermeable element described above. This embodiment constructs a three-dimensional object in a “top-down” way.

The apparatus includes the following structure:

a main frame 31 constituting the frame structure of the 3D printing apparatus;

a workbench 32 on which a three-dimensional object is constructed and which connects with a one-dimensional electric platform, wherein the workbench 32 is driven by the one-dimensional electric platform to move up and down under the control of a controller 37;

a semipermeable element 33 which is an optically transparent, oxygen-permeable element and which is manufactured using a nuclear track etching technique; in this embodiment, as shown in the SEM picture of FIG. 5, the semipermeable element has a pore density of 10⁸/cm², and a pore diameter of 0.15 μm. And the gas permeability is no less than 100 bar;

wherein the lower surface of the semipermeable element 33 is a manufacturing surface, together with which the upper surface of the workbench 32 form the construction zone for the three-dimensional object;

a liquid tank 34, which is a container for the polymerizable liquid, in which the workbench 32 is located;

a curing inhibitor source 35 used to provide a curing inhibitor, wherein the upper surface of the semipermeable element 33 is in contact with the curing inhibitor source 35, and the curing inhibitor can penetrate into the construction zone through the semipermeable element 33 and form a liquid inhibited curing layer 39 between the manufacturing surface and the cured area 38. In this embodiment, oxygen or air is used as the curing inhibitor;

a light source 36, which is located above the semipermeable element 33, and the light source 36 irradiates the construction zone through the semipermeable element 33 to initiate the curing of the polymerizable liquid; and

a controller 37 which connects and controls the light source 36 and the workbench 32.

The operation of the apparatus is as follows:

(1) adding a sufficient amount of polymerizable liquid (sufficient to form the final three-dimensional object) into the liquid tank 34 and making the level not lower than the manufacturing surface, and elevating the workbench 32 and getting closed to the covering surface;

(2) irradiating the construction zone with the light source 36 and introducing the curing inhibitor. In this step, the light source 36 irradiates the construction zone to form a cured area 38, and the curing inhibitor in the curing inhibitor source 35 is enriched on the manufacturing surface through the semipermeable element 33. Due to the effect of the curing inhibitor, a liquid inhibited curing layer 39 is formed between the manufacturing surface and the light cured area 38;

(3) moving the workbench 2 away from the manufacturing surface under the control of the controller 37. With the presence of the liquid inhibited curing layer 39, the cured area 38 is easily and non-destructively separated from the manufacturing surface to form a subsequent construction zone, into which the polymerizable liquid is filled;

(4) repeating the above steps (2) and (3) and performing the layer-by-layer deposition until the three-dimensional object 30 is formed.

Compared with commercially available sponge-like microporous polymer as the semipermeable elements, the gas permeability of the semipermeable element according to the present invention increases by 6 times, and the printing speed of the 3D printing apparatus can reach 550 mm/h.

Embodiment 3:

Same methodology as in Embodiment 1 is used with the following exception: the semipermeable element has a pore density of 10⁹/cm², and/or has a pore diameter of 0.1 μm. The gas permeability is no less than 120 bar.

Compared with commercially available sponge-like microporous polymer as the semipermeable elements, the gas permeability of the semipermeable element according to the present invention increases by 7 times, and the printing speed of the 3D printing apparatus can reach 570 mm/h.

Embodiment 4:

Same methodology as in Embodiment 2 is used with the following exception: the semipermeable element has a pore density of 2×10⁹/cm², and/or has a pore diameter of 0.05 μm. The gas permeability is no less than 150 bar. Compared with commercially available sponge-like microporous polymer as the semipermeable elements, the gas permeability of the semipermeable element according to the present invention increases by 8 times, and the printing speed of the 3D printing apparatus can reach 600 mm/h.

The embodiments of the present invention have been described above. However, the present invention is not limited to the above-described embodiments. Any modification, equivalent alternation and development made within the scope and principle of the present disclosure fall within the protection scope of the present disclosure.

1. A 3D print apparatus, comprising:
a main frame constituting the frame structure of the apparatus;
a workbench on which a three-dimensional object is constructed and which connects with a one-dimensional electric platform, wherein the workbench is driven by the one-dimensional electric platform to move up and down under the control of a controller;
a semipermeable element which is an optically transparent, oxygen-permeable element and which is manufactured using a nuclear track etching technique; in this embodiment, the semipermeable element has a pore density of 10⁷/cm², and a pore diameter of 1 μm; the gas permeability is no less than 100 barrer;
a liquid tank, wherein the semipermeable element and the liquid tank constitute a container for the polymerizable liquid, the surface of the semipermeable element near the workbench being a manufacturing surface of the three-dimensional object and as the bottom of the container for the polymerizable liquid container, and wherein a construction zone of the three-dimensional object is formed between the lower surface of the workbench and the manufacturing surface;
a curing inhibitor source used to provide a curing inhibitor, wherein the lower surface of the semipermeable element is in contact with the curing inhibitor source, and the curing inhibitor can penetrate into the construction zone through the semipermeable element and form a liquid inhibited curing layer between the manufacturing surface and the cured area;
oxygen or air is used as the curing inhibitor;
a light source which is located below the semipermeable element, and irradiates the construction zone through the semipermeable element to initiate the curing of the polymerizable liquid; and
a controller which connects and controls the light source and the workbench.

2. A 3D print apparatus, comprising:
a main frame constituting the frame structure of the 3D printing apparatus;
a workbench on which a three-dimensional object is constructed and which connects with a one-dimensional electric platform, wherein the workbench is driven by the one-dimensional electric platform to move up and down under the control of a controller;
a semipermeable element which is an optically transparent, oxygen-permeable element and which is manufactured using a nuclear track etching technique; the semipermeable element has a pore density of 10⁸/cm², and a pore diameter of 0.15 μm; and the gas permeability is no less than 100 barrer;
wherein the lower surface of the semipermeable element is a manufacturing surface, together with which the upper surface of the workbench form the construction zone for the three-dimensional object;
a liquid tank, which is a container for the polymerizable liquid, in which the workbench is located;
a curing inhibitor source used to provide a curing inhibitor, wherein the upper surface of the semipermeable element is in contact with the curing inhibitor source, and the curing inhibitor can penetrate into the construction zone through the semipermeable element and form a liquid inhibited curing layer between the manufacturing surface and the cured area;
oxygen or air is used as the curing inhibitor;
a light source, which is located above the semipermeable element, and the light source irradiates the construction zone through the semipermeable element to initiate the curing of the polymerizable liquid; and
a controller which connects and controls the light source and the workbench.

3. A 3D print apparatus, comprising:
a main frame constituting the frame structure of the apparatus;
a workbench on which a three-dimensional object is constructed and which connects with a one-dimensional electric platform, wherein the workbench is driven by the one-dimensional electric platform to move up and down under the control of a controller;
a semipermeable element which is an optically transparent, oxygen-permeable element and which is manufactured using a nuclear track etching technique; in this embodiment, the semipermeable element has a pore density of 10⁹/cm², and a pore diameter of 0.1 μm; the gas permeability is no less than 120 barrer;
a liquid tank, wherein the semipermeable element and the liquid tank constitute a container for the polymerizable liquid, the surface of the semipermeable element near the workbench being a manufacturing surface of the three-dimensional object and as the bottom of the container for the polymerizable liquid container, and wherein a construction zone of the three-dimensional object is formed between the lower surface of the workbench and the manufacturing surface;
a curing inhibitor source used to provide a curing inhibitor, wherein the lower surface of the semipermeable element is in contact with the curing inhibitor source, and the curing inhibitor can penetrate into the construction zone through the semipermeable element and form a liquid inhibited curing layer between the manufacturing surface and the cured area;
oxygen or air is used as the curing inhibitor;
a light source which is located below the semipermeable element, and irradiates the construction zone through the semipermeable element to initiate the curing of the polymerizable liquid; and
a controller which connects and controls the light source and the workbench.

4. A 3D print apparatus, comprising:
a main frame constituting the frame structure of the 3D printing apparatus;
a workbench on which a three-dimensional object is constructed and which connects with a one-dimensional electric platform, wherein the workbench is driven by the one-dimensional electric platform to move up and down under the control of a controller;
a semipermeable element which is an optically transparent, oxygen-permeable element and which is manufactured using a nuclear track etching technique; the semipermeable element has a pore density of 2×10⁹/cm², and a pore diameter of 0.05 μm; and the gas permeability is no less than 150 barrer;
wherein the lower surface of the semipermeable element is a manufacturing surface, together with which the upper surface of the workbench form the construction zone for the three-dimensional object;
a liquid tank, which is a container for the polymerizable liquid, in which the workbench is located;
a curing inhibitor source used to provide a curing inhibitor, wherein the upper surface of the semipermeable element is in contact with the curing inhibitor source, and the curing inhibitor can penetrate into the construction zone through the semipermeable element and form a liquid inhibited curing layer between the manufacturing surface and the cured area;
oxygen or air is used as the curing inhibitor;
a light source, which is located above the semipermeable element, and the light source irradiates the construction zone through the semipermeable element to initiate the curing of the polymerizable liquid; and
a controller which connects and controls the light source and the workbench.
